(19) United States
(12) Patent Application Publication
(10) Pub. No.: US 2012/0254196 A1
(43) Pub. Date: Oct. 4, 2012

(54) SYSTEMS FOR EVALUATING DIETARY INTAKE AND METHODS OF USING SAME

(75) Inventors: Catherine Patricia Abramski, Chester, NJ (US); Cheryl Callen, Short Hills, NJ (US); Susan Gerberg Pac, West Caldwell, NJ (US); Stefani Warren, Westlake Village, CA (US)

(73) Assignee: NESTEC S.A., Vevey (CH)

(21) Appl. No.: 13/501,308

(22) PCT Filed: Jul. 12, 2010
(86) PCT No.: PCT/US10/41709

§ 371 Date: Jun. 19, 2012

Related U.S. Application Data
(60) Provisional application No. 61/251,145, filed on Oct. 13, 2009.

(51) Int. Cl. G06F 17/30

(52) U.S. Cl. 707/748; 707/E17.044

(57) ABSTRACT

Systems and methods for ensuring that a child receives proper nutrition specific to the child's developmental stage or pre-existing condition are provided. In a general embodiment, the present disclosure provides systems including a client device having at least one database, which has stored food consumption information and child characteristic information. The database further includes stored nutrient and food group recommendation information, and a rating system. Processors are used to calculate an average daily nutrition value of a child based on the food consumption and child characteristic information, compare the average daily nutrition value to the nutrient and food group recommendation information, and output a rating score based on the comparison.

### BACKGROUND

The present disclosure generally relates to health and nutrition. More specifically, the present disclosure relates to systems and methods for ensuring that children receive proper nutrition that is appropriate to the child's developmental stage.

Food and nutrition are at the core of a child's growth and development. Indeed, healthy eating contributes to overall healthy growth and development in children, which includes, for example, healthy bones, skin, energy levels and cognitive development. Healthy eating also contributes to a lowered risk of, for example, dental caries, eating disorders, constipation, malnutrition, and iron deficiency anemia.

However, many parents find it difficult to establish a healthy eating menu and schedule for their children that contains all of the nutrients and food groups required for proper nutrition. This may be especially difficult for parents in view of the varying nutritional needs of children in different age groups and at different stages of development. The problem of insufficient nutrition is significant because when children go without necessary nutrients, vital developmental milestones may be affected including, for example, cognitive development and the build-up of immunity.

### SUMMARY

Systems and methods for ensuring that a child receives proper nutrition specific to the child's developmental stage are provided. In a general embodiment, the present disclosure provides systems for calculating an average daily nutrient intake of a child. The systems include, for example, a client device having a processor and at least one database operatively coupled to the processor. The database includes stored food consumption information, stored child characteristic information, stored nutrient and food recommendation information, a stored rating system, and stored instructions. The stored instructions cause the processor to calculate an average daily nutrition value based on the food consumption information, compare the average daily nutrition value to the stored nutrient and food recommendation information, and output a rating score based on the comparison.

In an embodiment, the system may further include an input device and/or an output device.

In an embodiment, the system further includes a communication channel. The communication channel may connect the client device to a remote server. The communication channel may be selected from the group consisting of the Internet, cable, satellite, local area network, wide area network, telephone network, or combinations thereof.

In an embodiment, the database is stored in a location selected from the group consisting of a memory, a storage device, a remote server, or combinations thereof.

In an embodiment, the stored nutrient and food group recommendation information is selected from the group consisting of recommended daily nutrient values, recommended daily food group values, or combinations thereof.

In an embodiment, the recommended daily nutrient values and recommended daily food group values are based upon a child's developmental stage. Alternatively, the recommended daily nutrient values and recommended daily food group values may be based upon a child's pre-existing condition. A pre-existing condition may be selected from the group consisting of diabetes, food allergies, digestive, cognitive development, immunosuppressed, low weight, high weight, or combinations thereof.

In an embodiment, the recommended daily nutrient values are provided for nutrients selected from the group consisting of carbohydrates, fats, proteins, vitamins, minerals, calories, or combinations thereof.

In an embodiment, the recommended daily food group values are provided for food groups selected from the group consisting of grains, vegetables, fruits, dairy, meats and beans, fats and oils, or combinations thereof.

In an embodiment, the food consumption information is selected from the group consisting of a type of food, an amount of food, a time of day the food is consumed, a date the food is consumed, or combinations thereof.

In an embodiment, the rating score is directly proportional to a degree of correlation between the average daily nutrition value and the stored nutrient and food group recommendation information.

In an embodiment, the rating score is based on a number of stars and the number of stars is indicative of the correlation between the average daily nutrition value and the stored nutrient and food group recommendation information.

In an embodiment, the child characteristics information is selected from the group consisting of weight, height, age, pre-existing conditions, or combinations thereof.

In another embodiment, methods for rating the nutritional value of a pre-planned menu of a child are provided. The methods include providing a processor and at least one database, inputting daily food consumption information for a pre-determined amount of time into the database to create a pre-planned menu, inputting child characteristic information into the database, calculating an average nutrition value for the predetermined number of days using the processor, comparing the average nutrition value to a value selected from the group consisting of recommended nutrient values, recommended food group values, or combinations thereof, determining a rating for the average nutrition value; and outputting a rating score for the pre-planned menu.

In an embodiment, the food consumption information is selected from the group consisting of a type of food, an amount of food, a time of day the food is consumed, a date the food is consumed, or combinations thereof.

In an embodiment, the recommended daily nutrient values are provided for nutrients selected from the group consisting of carbohydrates, fats, proteins, vitamins, minerals, calories, or combinations thereof.

In an embodiment, the recommended daily food group values are provided for food groups selected from the group consisting of gains, vegetables, fruits, dairy, meats and beans, fats and oils, or combinations thereof.

In an embodiment, the recommended daily nutrient values and recommended daily food group values are based on a child's developmental stage. Alternatively, the recommended daily nutrient values and recommended daily food group values may be based on a child's pre-existing condition. The pre-existing conditions are selected from the group consisting of diabetes, food allergies, digestive, cognitive development, immunosuppressed, low weight, high weight, or combinations thereof.

In an embodiment, the child characteristics information is selected from the group consisting of weight, height, age, pre-existing conditions, or combinations thereof.

In yet another embodiment, methods for adjusting a dietary intake of a child are provided. The methods include providing a processor and at least one database having stored child characteristic information, calculating an average nutrition value of a child's dietary intake using the processor, comparing the average nutrition value to a value selected from the group consisting of recommended nutrient values, recommended food group values, or combinations thereof, determining a rating score for the average nutrition value based on information selected float the group consisting of a child's developmental stage, a child's pre-existing condition, or combinations thereof, and adjusting the child's dietary intake if the rating score is below a predetermined rating score.

In an embodiment, the rating score is a star rating score. The predetermined rating score may be, for example, three stars.

In an embodiment, the child's dietary intake is adjusted to include additional foods that provide nutrients and/or food groups to cause the rating score to increase.

In an embodiment, the child characteristics information is selected from the group consisting of weight, height, age, pre-existing conditions, or combinations thereof.

In an embodiment, the pre-existing conditions are selected from the group consisting of diabetes, food allergies, digestive, cognitive development, immunosuppressed, low weight, high weight, or combinations thereof.

An advantage of the present disclosure is to provide an improved system for determining the nutritional value of a child's diet based on the child's developmental stage and/or pre-existing condition.

Another advantage of the present disclosure is to provide a method of calculating an average nutrition value of a child's dietary intake.

Yet another advantage of the present disclosure is to provide an interactive menu planner to aid in tracking a child's dietary intake.

Still yet another advantage of the present disclosure is to provide a computer-based program to aid in providing children with a nutritionally complete menu.

Additional features and advantages are described herein, and will be apparent from the following Detailed Description.

### BRIEF DESCRIPTION OF THE FIGURES

FIG. 1 is a schematic representation of an interactive menu planner system in accordance with an embodiment of the present disclosure.

FIG. 2 is a schematic representation of an interactive menu planner system in accordance with another embodiment of the present disclosure.

FIG. 3 is a is a high level flowchart depicting a method of menu planning in accordance with an embodiment of the present disclosure.

### DETAILED DESCRIPTION

Parents and caretakers may find it difficult to monitor a child's nutritional intake for various reasons. Indeed, the dietary intake of children can vary widely from day to day or meal to meal. For example, a child may consume a large amount of food at breakfast and a comparatively small amount of food at dinner, Similarly, a child may eat healthy at home but eat less healthy foods when away from the home. Although such variations and unpredictability of a child's diet are normal and expected with children, such variations make it difficult for a parent or caretaker to ensure that the child is receiving proper nutrition.

In order to ensure that a child receives the proper amount of nutrients for child's specific developmental stage, it may be advantageous to provide parents and caretakers with an easy-to-use, convenient and quick way to monitor a child's diet. Once such way to achieve this result is to provide parents or caretakers with an interactive menu planner that evaluates and creates menus for a child based on, for example, actual and recommended daily, weekly, or monthly requirements of nutrients, food groups and calories per stage of development for a child. For the convenience of the parent or caretaker, the interactive menu planner may include a unique rating system that will rate the quality of a child's menu on a pre-determined scale, which correlates to recommended nutrient and food group values specific to a child's developmental stage.

The interactive menu planner system of the present disclosure may be used by parents to ensure that their children are receiving proper nutrition on a daily basis. The interactive menu planner may be used as a backward-looking tool to determine why the child did not obtain enough nutrients over a given period of time, or, conversely, what type of menu provided the child with proper nutrition. Similarly, the interactive menu may be used as a forward-looking tool to prepare, for example, a weekly menu for child that provides the child sufficient nutrition for that week.

Similarly, the interactive menu planner may be used by parents to monitor children having pre-existing conditions who may require special dietary needs. For example, the interactive menu planner may specifically tailored for children who suffer from diabetes by regulating the amount of sugar in the child's diet. Similarly, the interactive menu planner may also be used to avoid certain foods that provoke allergic reaction in the child. The interactive menu planner may also be able to monitor the amount of calories that a child suffering from childhood obesity consumes, in general, the interactive menu planner may be able to take into consideration several pre-existing conditions including, for example, whether a child is a picky eater, consumes too much fat or calories, lacks essential vitamins, minerals or other nutrients, suffers from pre-existing medical conditions such as, for example, diabetes, food allergies, attention deficit disorder, a cognitive development issue, etc.

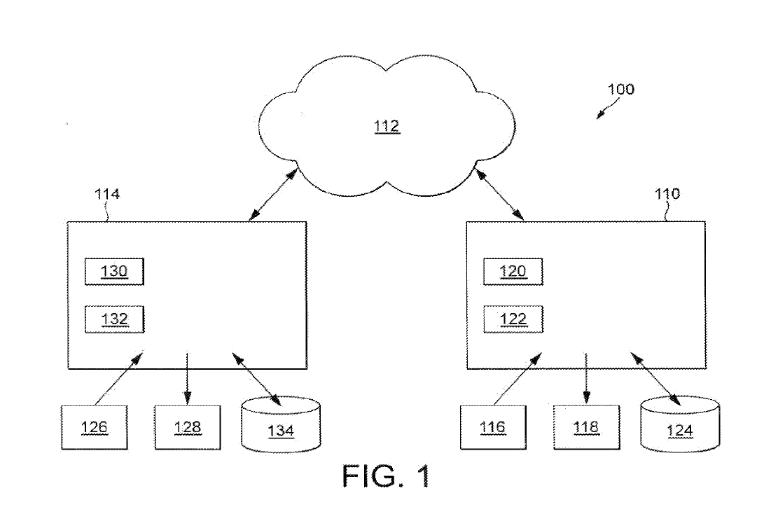

FIG. 1 illustrates a schematic of the interactive menu planner system 100 in an embodiment of the present disclosure. The interactive menu planner system 100 allows a user to monitor, tailor, plan and review past dietary intake information or future dietary intake. In an embodiment, the user may be a parent or a caretaker of a child and the dietary intake may be that of a child. In an embodiment, the interactive menu planner system 100 includes a client device 110, a communication channel 112 and a remote server 114.

Client device 110 may include an input device 116, an output device 118, a memory 120, a processor 122 and at least one storage device 124. Client device 110 may be, for example, a personal computer (“PC”), a personal digital assistant (“PDA”), a portable audio/video player, a mobile telephone, a pager, etc. Generally speaking, client device 110 may comprise any device capable of providing, receiving and executing instructions (e.g., computer programs).

Memory 120, storage device 124 and processor 122 provide the user with access to, and storage of, information. The skilled artisan would immediately appreciate that memory 120 and storage device 124 may be alternative or complementary mechanisms for accessing and storing information. Accordingly, the skilled artisan would also appreciate that the information necessary to operate various embodiments of the interactive menu planner system 100 may be stored in memory 120, storage device 124, or combinations thereof.

Memory 120 and storage device 124 may be used to store various information including, for example, processor instructions, software programs and specific databases. Storage device 124 may include one, single, large database or a plurality of smaller linked databases. Storage device 124 may be, for example, a hard drive, CD drive, DVD drive, and/or other storage devices, and may store any type of data such as content data, database records, commands, etc. The user should be able to edit information stored in memory 120 and/or storage device 124 and select how the database presents information to a user.

For example, memory 120 and/or storage device 124 may store a consumer information database that stores, for example, consumer characteristic information and food consumption information input by the consumer. Memory 120 and/or storage device 124 may also include one or more databases that contain dietary information. For example, such a dietary database may include typically consumed foods and their associated nutritional information and proper food group categorization. Further, memory 120 and/or storage device 124 may also include a database of recommended nutrient values and food groups that are dependent on specific consumer characteristics. For example, memory 120 and/or storage device 124 may include databases of recommended nutrient values and food groups for a consumer that is an infant, a toddler, a pre-teenage child, a teenage child, a child having a pre-existing condition, etc.

In another embodiment, memory 120 and/or storage device 124 may include a database having nutritional information about specific brand name pre-packaged food products. For example, the nutrition& information for GERBER® GRADUATES® Fruit Puffs may be stored in a database. The use of such databases allows a user to input the types and amounts of food consumed or to be consumed in the future and to have the client device 110 return specific nutritional information to the user regarding their dietary intake.

Processor 122 may be any suitable processing device that is able to provide and receive information and to execute instructions (e.g., computer programs). Processor 122 must also be capable of accessing databases, manipulating data, calculating values and sending results of calculations to output device 118.

Input device 116 allows the user to input various types of information to be used by processor 122. Input device 116 may be a mouse, keyboard, temporary storage device, touch screen, track pad, track ball, isopoint, knob, voice recognition system, etc. The information that may be input into client device 110 may include login or identification information, consumer characteristic data, dietary intake information, personal notes taken by the user, etc.

Output device 118 may visually and dynamically communicate information to the user. Output device 118 may be any device that is capable of delivering information to a user and may be, for example, a conventional computer monitor, cathode ray tube (“CRT”), liquid crystalline display (“LCD”), the screen of a hand-held device, printers, speakers, etc. The information output to the user may include, for example, a user profile, a pre-planned weekly menu, a pre-planned monthly menu, an average amount of calories consumed during a pre-determined amount of tune, a prompt for user input, calculated values, data, etc.

Client device 110 may be connected to and communicate with remote server 114 via a communication channel 112. Communication channel 112 may be any suitable communication channel 112 such as the Internet, cable, satellite, local area network, wide area network, telephone network, etc. Specifically, the communication channel 112 may be any type of network connection such as, for example, an Ethernet connection, WiFi, WiMax, digital subscriber line (“DSL”), telephone line, coaxial cable, etc. In an embodiment, communication channel 112 is the Internet. The skilled artisan would immediately appreciate that although not depicted, where communication channel 112 is wireless, interactive menu planner system 100 may include a wireless muter configured to send and receive information from a handheld client device.

Similar to memory 120 and storage device 124, communication channel 112 may provide access to and storage of information via remote server 114. The information stored remotely may be similar to the information stored on memory 120 and/or storage device 124. For example, remote server 114 may store consumer characteristic information, food consumption information, food group information, nutritional information, etc. The information stored on remote server 114 may be stored in, for example, one large database or several small databases. Accordingly, memory 120, storage device 124 and remote server 114 may be used alternatively or in conjunction with one another such that, for example, a first database may be stored on memory 120, a second database may be stored on storage device 124, and a third database may be stored on remote server 114, which is accessible via communication channel 112.

Remote server 114 may include an input device 126, an output device 128, a memory 130, a processor 132 and a storage device 134, all of which perform substantially the same function as input device 116, output device 118, memory 120, processor 122 and storage device 124, respectively, and as described above.

in an embodiment, a user may access interactive menu planner system 100 by logging into, or registering with, system 100 via a web page displayed on output device 118. After accessing the information, a user may be prompted to input certain information including, for example, consumer characteristic information and food consumption information, which may be stored in memory 120, storage device 124, remote server 114, or combinations thereof. The information may be stored in one single database or separate databases. In an embodiment, the consumer is a child of a specific developmental stage. Child characteristic information may include, for example, weight, height, age (e.g., date of birth), pre-existing conditions, etc. Pre-existing conditions may include, for example, whether a child is a picky eater, consumes too much fat or calories, lacks essential vitamins, minerals or other nutrients, or suffers from pre-existing medical conditions such as, for example, diabetes, food allergies, digestive issues, attention deficit disorder, cognitive development issues, immunosuppression, low weight, high weight, etc.

Food consumption information may be stored in memory 120, storage device 124, remote server 114, or combinations thereof, and may be stored in one single database or separate databases. Food consumption information may include, for example, types of food, amounts of food, a time of day to consume the food, a date the food was, or is to be, consumed, or combinations thereof. In an embodiment, food consumption data comprises a pre-planned menu for a pre-determined amount of time.

Memory 120, storage device 124 and/or remote server 114 may also have additional information stored therein including, for example, stored nutrient and food group information. In an embodiment, stored nutrient and food group information may include a database of recommended nutrient and food group values that correspond to a specific developmental stage of a child. For example, such a database may include appropriate nutrient values and food group values for an infant. A similar database may include appropriate nutrient values and food group values for a toddler. Further, a database may also generally include typical sources of food and nutritional values associate therewith.

Typically, nutrient values are provided for nutrients including, for example, protein, carbohydrates, fat, vitamins, minerals, calories, sugar etc. Food group values are also typically provided for food groups including, for example, grams (including, among others, bread, cereal, rice and pasta), dairy (including, among others, milk, yogurt and cheese), vegetables, fruits, meat and beans (including, among others, meats, poultry, fish, beans, eggs and nuts), and fats, oils and sweets. (e.g., fruits, vegetables, grains, etc.).

Additionally, memory 120, storage device 124 and/or remote server may also have a stored rating system that provides a score that corresponds to the quality of nutrition provided in a child's proposed or previously consumed menu. The rating system may provide a rating score of one to five. In an embodiment, the rating system is a star rating system having a possible rating score of one star (being the lowest rating) up to five stars (being the highest rating). However, the skilled artisan will appreciate that the rating system need not be a score of one to five, nor is the rating system required to be a star rating system. Instead, the rating system may be a score of one to one hunched, for example, or may be a letter grade rating score ranging from an “A” (being the highest rating) to an “F” (being the lowest rating). The rating score may also be a low, medium, high rating or a poor to excellent rating.

In an embodiment, the rating system is a star rating system, if all the key nutrients and food groups in a proposed or consumed menu meet the recommended values, the menu is rated at Five Stars. Table 1 provides an example of what a possible five star rating system may look like.

TABLE 1

| Star Rating | Means . . . |
|---|---|
| * | At least 1 complete day is filled in but more than 2 nutrients |
| | and 2 food groups are not meeting recommendations. |
| ** | Good start, but 2 nutrients and/or 2 food groups are not |
| | meeting recommendations. |
| *** | Solid Foundation. All nutrients may be meeting |
| | recommendations, but one food group is missing OR |
| | 1 nutrient and 1 food group may not be meeting |
| | recommendations. |
| **** | Very Good. All key nutrients are meeting |
| | recommendations. Just one food group recommendation is |
| | not yet met. |
| ***** | Excellent! All key nutrients and food groups meet |
| | recommendations! |

As discussed above, the interactive menu planner system 100 may be used where a child has a pre-existing condition that requires a special diet. In certain of these instances, the interactive menu planner system 100 may be able to provide a unique rating system to ensure that the child suffering from the pre-existing condition is receiving all of the necessary nutrients and food groups. For example, where a child is a special needs child that suffers from cognitive development issues, it may be especially difficult for a parent or caretaker to ensure that the child consumes certain types of foods. In this instance, the interactive menu planner's rating system may be especially tailored to the child's dietary needs, which may include, for example, greater recommended amounts of fatty acids such as docosahexaenoic acid or eicosapentaenoic acids.

In an embodiment, the interactive menu planner system 100 may include a diary feature that allows a user to store information about or take notes on past menus, a child's eating habits, ideas for future menus, etc. The diary may be accessible from a home web page after a user accesses the interactive menu planner system 100.

In an exemplary process, a user may log in to or register with the interactive menu planner system 100 using input device 116. Once accessed, the user may be prompted to input information such as consumer characteristic information and food consumption information, as discussed above. In an embodiment, the consumer characteristic information is child characteristic information and the food consumption is a proposed menu for a pre-determined amount of time. After entering the above-mentioned information, the user may instruct processor 122, 132 to calculate an average nutrition value of the proposed menu. After calculating an average nutrition value, processor 122, 132 compares the average nutrition value to recommended nutrient and food group values specific to the child's developmental stage. The comparison aids in determining whether a child's diet has provided the child with proper nutrition based on the child's characteristics, which include, for example, developmental stage and pm-existing conditions.

Once processor 122, 132 has compared the average nutrition values to recommended nutrient and food group values, processor 122, 132 may access stored rating system information to provide a rating score for the pre-planned menu according to a predetermined rating scale, as discussed above. The rating score is reflective of the correlation between the nutritional content of a pre-planned menu and recommended nutrient and food getup information based upon consumer (e.g., a child) characteristic information.

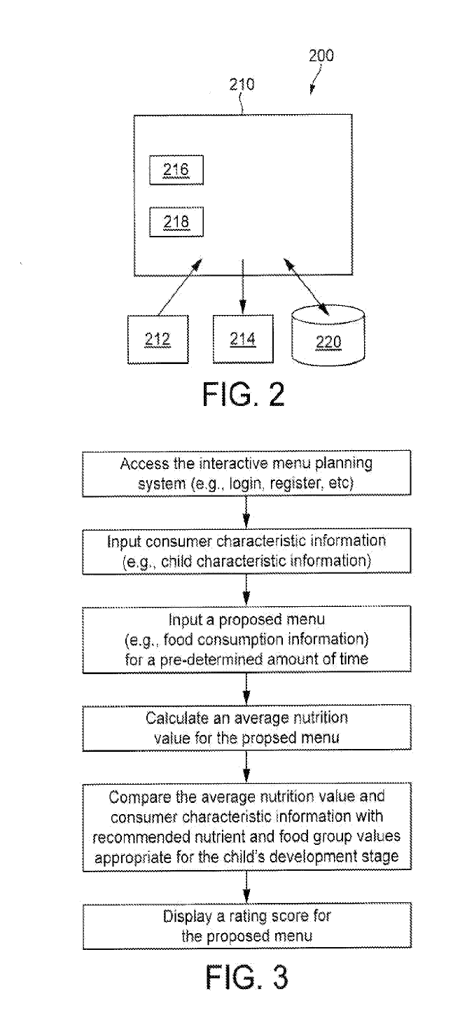

In an alternative embodiment, FIG. 2 demonstrates a schematic of a interactive menu planner system 200 that operates without the use of communication channels. The interactive menu planner system 200 includes a client device 210 having an input device 212, an output device 214, a memory 216, a processor 218, and at least one storage device 220, all of which have similar functions to the elements of the interactive menu planner system 100 described above. In this embodiment, however, processor 218 of client device 210 is able to operate without the use of a communication channel such as the internet, cable, satellite, local area networks, wide area networks, telephone networks, etc. Instead, processor 218 receives instructions from a computer program or software stored in memory 21 or storage device 220. Accordingly, in an embodiment client device 210 is a PC that executes a computer program or software contained on any suitable computer readable storage device 220 including a hard disk, a floppy disk, a compact disk, a flash drive, etc.

In an exemplary process, a user may input consumer specific information into client device 210 via input device 212, which may be stored in memory 216 or storage device 220. Storage device 220 may be any storage device such as, for example, a hard drive, CD drive, DVD drive, and/or other storage devices connected to client device 210. Memory 216 and storage device 220 may store any type of data used by client device 210 including, as discussed above, consumer characteristic data, consumer consumption information, recommended nutrient and food group information, a rating system, a diary of the user, etc. When prompted by a user to evaluate, for example, either a menu plan input by a user or the nutritional content of a past menu, processor 218 will pull pertinent information from memory 216 or storage device 220, perform the required logic as instructed by the program or software, and output results to output device 214. Therefore, in this manner, the convenience of the presently disclosed interactive menu planner system 200 may be enjoyed by users that may not have access to certain communication channels such as the internet.

FIG. 3 illustrates one embodiment of a general process by which a menu plan may be generated 300. To begin the process, a user must access the interactive menu planner system 310. In this step, the user may be asked to register or login to the system and may be prompted to input information such as an email address, username, password, etc. The user may then be prompted to input consumer characteristic data 312 and a proposed menu 314. As discussed above, consumer characteristic information may include, for example, a consumer's gender, age (e.g., birth date), weight, height, food preferences, existing conditions, activity level, or combinations thereof. Additionally, the proposed menu will include food consumption information as discussed above, which may include, for example, a type of food, an amount of food, a time of day the food is consumed, a date the food is to be consumed, or combinations thereof.

Upon entering all of the necessary information, a user may instruct the system to calculate an average nutrition value for the menu 316. The average nutrition value may be specific to nutrients including, for example, protein, carbohydrates, fats, vitamins, minerals, calories, specific food groups, etc, and/or food groups including, for example, fruits, vegetables, grains, meats and beans, fats, oils, sweets, etc. Once an average nutrition value has been calculated, the average nutrition value may be compared to a recommended nutrient and food group database appropriate for the child's developmental stage 318. Based on the comparison, the system will display a rating score for the proposed menu 320, which is indicative of the quality of nutrition in a proposed menu to be provided to a child at a specific developmental stage or having a pre-existing condition.

Methods of using the above-described systems are also provided. For example, methods for rating the nutritional value of a pre-planned menu of a child are provided. The methods include providing a processor and at least one database, inputting daily food consumption information for a pre-determined amount of time into the at least one database to create a pre-planned menu, inputting child characteristic information into the at least one database, calculating an average nutrition value for the predetermined number of days using the processor, comparing the average nutrition value to a value selected from the group consisting of recommended nutrient values, recommended food group values, or combinations thereof, determining a rating for the average nutrition value, and outputting a rating score for the pre-planned menu.

Additionally, methods for adjusting a dietary intake of a child are provided. The methods include providing a processor and at least one database having stored child characteristic information, calculating an average nutrition value of a child's dietary intake lasing the processor, comparing the average nutrition value to a value selected from the group consisting of recommended nutrient values, recommended food group values, or combinations thereof, determining a rating score for the average nutrition value based on information selected from the group consisting of a child's developmental stage, a child's pre-existing condition, or combinations thereof, and adjusting the child's dietary intake if the rating score is below a predetermined rating score.

By way of example and not limitation, the following Example is illustrative of an embodiment of an interactive menu planner system of the present disclosure.

### Example 1

In this example, the interactive menu planner calculates the average caloric intake for a toddler over a five day period. To begin, child characteristic data including, for example, the child's height, weight and pre-existing conditions is input and stored in the system. Additionally, food consumption information is recorded including, among others, the caloric intake value for each day, which is as follows:

Day 1 900 calories

Day 2 850 caloric

Day 3 1000 calories

Day 4 1100 calories

Day 5 900 calories

The average caloric intake for these five days is 950 calories. Once the interactive menu planner has determined the average nutrition value (e.g., calories in this case) for the menu, it compares those values with the recommended nutrient and food group values appropriate to the child's developmental stage. In the present example, this comparison indicates that an average of 950 calories for a toddler is an appropriate amount for the toddler's developmental stage. The interactive menu planner may use the same evaluation process for other nutritional values in the child's five-day menu including nutrients such as, but not limited to, protein, carbohydrates, fat, vitamins, minerals, calories, sugar etc., and food groups such as but not limited to grains (including, among others, bread, cereal, rice and pasta), diary (including, among others, milk, yogurt and cheese), vegetables, fruits, meat and beans (including, among others, meats, poultry, fish, beans, eggs and nuts), and fats, oils, and sweets, etc.

Upon evaluation of the nutrients and food groups, the processor generates a rating score to reflect whether the menu provides proper nutrition based on a consumer's characteristics (e.g., a child's developmental stage, pre-existing conditions, etc.). For example, with respect to the present caloric intake evaluation, which indicated that the caloric intake was appropriate for the toddler, the rating system may return a five-star rating score. As shown above at Table 1, a five-star rating score may indicate to the child's parent or caretaker that the menu served to the child that week was “excellent,” and that the caloric intake met the recommended nutrient and food group values.

Although the average caloric intake value was appropriate for the child's developmental stage, without calculation of an average nutrition value (e.g., caloric intake), the child's dietary intake for the five-day menu may seem inadequate. For example, if Day Two was the only day considered, it may appear that the toddler did not get enough calories in its daily diet. Perhaps, however, on that day the toddler did not like what was served for dinner or tell asleep before lunch time. Similarly, on Day Four, it may appear that the toddler consumed too many calories. However, the toddler may have spent the day outside running and playing and then consumed a second helping of the toddler's favorite dinner. Thus, the average amount of nutrition (e.g., calories) more accurately reflects this toddler's usual intake and, therefore, is a more useful number to use when making nutrition decisions.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for rating the nutritional value of a pre-planned menu for a child, the system comprising:
a client device comprising a processor and at least one database operatively coupled to the processor, the at least one database comprising:
food consumption information,
child characteristic information,
stored nutrient and food recommendation information,
a stored rating system; and
stored instructions to cause the processor to:
calculate an average daily food into intake based on the food consumption information,
compare the average daily food intake to the stored nutrient food recommendation information, and
output a rating score based on the comparison.

2. The system of claim 1 further comprising an input device.

3. The system of claim 1 further comprising output device.

4. The system of claim 1 further comprising a communication channel.

5. The system of claim 1 wherein at least one of the food consumption information and child characteristic information is inputted into the client device by the user when it is desired to calculate the rating score.

6. The system of claim 1 wherein the food consumption information and child characteristic information is stored in the processor.

7. The system of claim 1 wherein the system will identify developmental stage based nutritional gaps in the food intake.

8. The system of claim 4, wherein the communication channel connects the client device to a remote server.

9. The system of claim 4, wherein the communication channel is selected from the group consisting of the Internet, cable, satellite, local area network, wide area network, telephone network, and combinations thereof.

10. The system of claim 1, wherein the at least one database is stored in a location selected from the group consisting of a memory, a storage device, a remote server, and combinations thereof.

11. The system of claim 1, wherein the stored nutrient and food group recommendation information is selected from the group consisting of recommended daily nutrient values, recommended daily food group values, and combinations thereof.

12. The system of claim 11, wherein the recommended daily nutrient values and recommended daily food group values are based upon a child's developmental stage.

13. The system of claim 11, wherein the recommended daily nutrient values and recommended daily food group values are based upon a child's pre-existing condition.

14. The system of claim 13, wherein the pre-existing condition is selected from the group consisting of diabetes, food allergies, digestive, cognitive development, immunosuppressed, low weight, high weight and combinations thereof.

15. The system of claim 11, wherein the recommended daily nutrient values are provided for nutrients selected from the group consisting of macronutrients, micronutrients carbohydrates, fats, proteins, vitamins, minerals, calories, and combinations thereof.

16. The system of claim 11, wherein the recommended daily food group values are provided for food groups selected from the group consisting of grains, vegetables, fruits, dairy, meats and beans, fats and oils, and combinations thereof.

17. The system of claim 1, wherein the food consumption information is selected from the group consisting of a type of food, an amount of food, a time of day the food is consumed, a date the food is consumed, and combinations thereof.

18. The system of claim 1, wherein the rating score is directly proportional to a degree of correlation between the average daily nutrition value and the stored nutrient and food group recommendation information.

19. The system of claim 18, wherein the rating score is based on a number of indicators and the number of indicators are indicative of the correlation between the average daily nutrition value and the stored nutrient and food group recommendation information.

20. The system of claim 1, wherein the child characteristics information is selected from the group consisting of weight, height, age, pre-existing conditions, and combinations thereof.

21. A method for rating the nutritional value of a pre-planned menu of a child, the method comprising:
providing a processor and at least one database;
inputting daily food consumption information for a pre-determined amount of time into the at least one database to create a pre-planned menu;
inputting child characteristic information into the at least one database;
calculating an average nutrition value for the predetermined number of days using the processor;
comparing the average nutrition value to a value selected from the group consisting of recommended nutrient values, recommended food group values, and combinations thereof;
determining a rating for the average nutrition value; and
outputting a rating score for the pre-planned menu.

22. The method of claim 21, wherein the food consumption information is selected from the group consisting of a type of food, an amount of food, a time of day the food is consumed, a date the food is consumed, and combinations thereof.

23. The method of claim 21, wherein the recommended daily nutrient values are provided for nutrients selected from the group consisting of carbohydrates, fats, proteins, vitamins, minerals, calories, and combinations thereof.

24. The method of claim 21, wherein the recommended daily food group values are provided for food groups selected from the group consisting of grains, vegetables, fruits, dairy, meats and beans, fats and oils, and combinations thereof.

25. The method of claim 21, wherein the recommended daily nutrient values and recommended daily food group values are based on a child's developmental stage.

26. The method of claim 21, wherein the recommended daily nutrient values and recommended daily food group values are based on a child's pre-existing condition.

27. The method of claim 21, wherein the child characteristics information is selected from the group consisting of weight, height, age, pre-existing conditions, and combinations thereof.

28. The method of claim 24, wherein the pre-existing conditions are selected from the group consisting of diabetes, food allergies, digestive, cognitive development, immunosuppressed, low weight, high weight, and combinations thereof.

29. A method for adjusting a dietary intake of a child, the method comprising:
providing a processor and at least one database having stored child characteristic information;
calculating an average nutrition value of a child's dietary intake using the processor;
comparing the average nutrition value to a value selected from the group consisting of recommended nutrient values, recommended food group values, and combinations thereof;
determining a rating score for the average nutrition value based on information selected from the group consisting of a child's developmental stage, a child's pre-existing condition, and combinations thereof; and
adjusting the child's dietary intake if the rating score below a predetermined rating score.

30. The method of claim 29, wherein the rating score is a star rating score.

31. The method of claim 30, wherein the predetermined rating score is three stars.

32. The method of claim 29, wherein the child's dietary intake is adjusted to include additional foods that provide nutrients and/or food groups to cause the rating score to increase.

33. The method of claim 9, wherein the child characteristics information is selected from the group consisting of weight, height, age, pre-existing conditions, and combinations thereof.

34. The method of claim 32, wherein the pre-existing conditions are selected from the group consisting of diabetes, food allergies, digestive, cognitive development, immunosuppressed, low weight, high weight, and combinations thereof.

35. A system for rating the nutritional value of a pre-planned menu for a child, the system comprising:
a client device comprising a processor and at least one database operatively coupled to the processor, the at least one database comprising:
food consumption information,
child characteristic information,
stored nutrient and food recommendation information,
a stored rating system; and
stored instructions to cause the processor to:
calculate an average weekly food intake based on the food consumption information,
compare the average weekly food intake to the stored nutrient and food recommendation information, and
output a rating score based on the comparison.

36. A system for calculating a rating score for a food intake comprising
a processor for receiving information food intake;
a stored rating score comprising a maximum rating if the food intake meets a predetermined minimum combination of stored nutrient and food recommendations, a minimum rating score if the nutrient and food recommendations fail to meet a minimum threshold and an average score; and
the processor outputting the rating score to a user based on food intake inputted the processor.
